(19) United States
(12) Patent Application Publication
(10) Pub. No.: US 2017/0266579 A1
(43) Pub. Date: Sep. 21, 2017

(54) Prop wrap

(71) Applicants: Alan D. Yefsky, Hawthorn Woods, IL (US); Amanda K. Reber, Elk Grove Village, IL (US); Richard K. Glenn, Schaumburg, IL (US); Amy G. Buckbee, Arlington Heights, IL (US)

(72) Inventors: Alan D. Yefsky, Hawthorn Woods, IL (US); Amanda K. Reber, Elk Grove Village, IL (US); Richard K. Glenn, Schaumburg, IL (US); Amy G. Buckbee, Arlington Heights, IL (US)

(73) Assignee: MCCORMICK'S GROUP, LLC, Arlington Heights, IL (US)

(21) Appl. No.: 15/460,224

(22) Filed: Mar. 15, 2017

Related U.S. Application Data
(60) Provisional application No. 62/310,023, filed on Mar. 18, 2016.

(51) Int. Cl. A63J 1/02; B32B 37/12; B32B 38/00

(52) U.S. Cl. CPC A63J 1/02; B32B 38/0004; B32B 37/12; B32B 38/145

(57) ABSTRACT

A prop wrap in the current invention can quickly and easily change the appearance of irregularly shaped rigid props used in pageantry art shows and enable the prop to graphically integrate with the show's concept, design, and theme. The prop wrap provides a flexible film on which an infinite number of designs can be applied. These designs include but are not limited to customized patterns that integrate tightly with the shows, school mascots, or group logos. By using the prop wrap a user is not limited to solid colors or simple patterns made available by conventional methods of painting or taping props. Each piece of the prop wrap incorporates a unique cutting pattern that matches a designated surface of a specific prop, such as a particular model and size of mock rifles, shakos, or shoes. This allows the prop wrap to align perfectly to the shape and size of the prop when it is affixed to the prop. The prop wrap also serves to protect the prop itself.

### FIELD OF THE DISCLOSURE

The current invention relates to wraps covering exterior surface of props used in marching band, color guard, dance, school spirit, and other pageantry arts.

### BACKGROUND OF THE INVENTION

Many scholastic institutions, including but not limited to high schools, colleges and universities, and middle schools, provide opportunities for students to participate in artistic, recreational, and athletic activities. Several of these activities, such as marching band, drum and bugle corps, color guard, and pompom and dance squads, can broadly be categorized as “pageantry arts”. In addition, many private and independent groups have formed outside the high school and college environments to pursue these activities. Both scholastic and independent groups often participate in competitive events which can span local, regional, national, and global levels.

Most pageantry arts programs incorporate choreographed music, dance, and a variety of show props such as intricate costuming, flags, mock rifles, sabres, sickles, batons, fabric panels, backdrops, pliable floor coverings, and the like, all of which are integrally coordinated with the theme or concept of the show being produced and performed. In recent years, the more advanced groups of performers have tightly integrated the graphic treatments on their costumes, flags, and vinyl floor coverings in an effort to present the most polished and developed show for competitions in which they participate. This integrated graphical treatment has been limited to fabric-based materials or pliable floor coverings, but has not been available for other important show props such as mock rifles, batons, sabres, sickles, and other irregularly-shaped rigid objects. Performers and their show designers have been unable to extend the show theme to these other materials and as such they “stand out” and aesthetically disrupt an otherwise integrated visual program.

Irregularly shaped rigid show props may be made of wood, metal, acrylic, plastic, carbon fiber, or other materials. Such props may also come in a variety of finishes that may include different colors or patterns provided at time of manufacture. However, the theme of a show typically changes from year to year. Applying customized finishes, colors, or patterns to props at time of manufacture is impractical because there would not be a way to make changes to a prop after it is produced. Accordingly, today virtually all these props are produced in a limited number of colors and patterns.

Because some of these products are produced from natural materials (e.g., wood), there are frequently variations from piece to piece, and because of the high degree of precision and practice associated with the performance of a show, performers have a need to practice and perform with the same exact prop once they develop a feel for the item. Switching one prop for another increases difficulty and risk during the performance and is not desired.

Paint or colored tape has been currently used for customizing such show props. This method is limited by the variations of available colors and the extent to which those colors coordinate with the other elements of the show. In addition, both paint and colored tape also lack the polish and high quality of finish that are incorporated in all other aspects of the show. Finally, colored tape does not provide the ability to create and apply any kind of theme or pattern (e.g., “floral”, “animals”, “rainforest”, or a high school mascot and logo) to these props.

Accordingly, there remains a need for a way to easily, quickly, and cost-effectively alter the appearance of irregularly shaped rigid show props in order to provide designers and performers the ability to change the appearance of such items to integrate with their shows.

### BRIEF SUMMARY OF THE INVENTION

A prop wrap in the current invention comprises at least one piece of flexible film. Unlike conventional painting or taping props, users are no longer to be limited to applying only solid colors or simple patterns such as stripes to props when the prop wrap is used. The prop wrap overcomes the limitations associated with the traditional wrapping material by providing a flexible film on which an infinite number of designs can be applied before it is quickly and easily affixed to the prop. The design on the prop wrap includes but is not limited to customized patterns that integrate tightly with other elements of a show or any of mascots, colors, and logos from schools or groups. While the prop wrap provides an ornamental effect to pageantry arts through the design, it also serves to protect the prop itself.

The prop wrap can be applied to a wide variety of irregularly shaped rigid props, including but not limited to mock rifles, sabres, sickles, flag poles, batons, decorative headwear, decorative footwear, rigid costume elements, and the like. In some embodiments of the invention, the prop wrap comprises one piece of flexible film having an apparent side with a design and an adhesive side for affixing to the prop and facilitating the application. In other embodiments of the invention, the prop wrap comprises more than one piece of flexible film for precisely covering different sides or surfaces of a prop. In some particular embodiments of the invention, the apparent side of the prop wrap is printable. In other particular embodiments of the invention, the prop wrap remains intact after it is manually detached from the prop before being reapplied to the prop. In some more particular embodiments of the invention, the prop wrap comprises a piece of flexible film for precisely covering an exterior side of a mock rifle, a shako, or a shoe's upper. In other more particular embodiments of the invention, the prop wrap comprises more than one piece of flexible film for precisely covering most or all exterior sides of a mock rifle, a shako, or a shoe's upper.

In some embodiments of the invention, the prop wrap is prepared by incorporating any design or pattern on a continuous sheet of flexible film, which is then pre-cut to precisely align with the surface appearance of a prop before it is attached to the prop. Performers are able to easily apply the prop wrap to the prop for changing its appearance. The entire process of applying the wrap to the prop may be completed in less than twenty minutes.

In some other embodiments of the invention, a custom-matched cutting pattern is developed for the prop wrap through a computerized program. The cutting pattern is printed on a continuous sheet of flexible film. After the shape is cut out from the sheet, the prop wrap is formed and ready for use. In some particular embodiments of the invention, based on the surface appearance and size of a prop such as mock rifle, shako, or shoe, a cutting pattern is precisely formed through a computerized program and printed on a continuous sheet of flexible film. After each shape on the cutting pattern is cut out from the sheet, it becomes the prop wrap and is ready to cover the corresponding surface of the prop.

### BRIEF DESCRIPTION OF THE DRAWINGS

FIG. 1 is the perspective view of a mock rifle during and after it is covered by the prop wrap.

FIG. 2 is the drawing of those cutout pieces of the prop wrap used for covering the mock rifle.

### DETAILED DESCRIPTION OF THE INVENTION

The current invention relates to prop wraps used to precisely cover the surface of props and methods for preparing same. The wraps can be applied to various props using by performers in different activities such as shows, parades, and plays. Prop wraps are made from flexible film including but not limited to vinyl, plastic, rubber, paper, laminated paper, other materials flexible enough to cover surface of a prop and any combination of said flexible materials. Depending on the size and appearance of a prop's surface that needs to be covered, the prop wrap may comprise more than one piece of flexible film. In some cases a prop wrap may be transparent.

A typical prop wrap in the current invention has two sides, the adhesive side and the apparent side. The adhesive side has composition that helps affix the wrap on a prop. While most of the wraps are designed to be removable from props after use, some of them may permanently stay on the props. An additional protective film is attached to the adhesive side of the prop wrap. This film is separable from the adhesive side. When the wrap is used, the protective film is removed and the adhesive side is attached to the surface of the prop for affixing the wrap to the body of the prop. Besides the means of self-adhesion, other methods for affixing the wrap on props such as taping may also be used in the current invention.

After the wrap is applied to the prop, the apparent side of the wrap becomes the exterior face of the prop and may have a design thereon. The design herein encompasses the coloring, patterning, and structuring of the apparent side of the wrap. Various patterns, images, or pictures can be created and formed on the apparent side of the wrap. They are formed by a process including but not limited to printing, painting, drawing, and dyeing.

Before it is affixed to the prop by a user, the prop wrap is cut out from a continuous sheet of flexible film based on the shape and size of the prop. For making the measurement the prop's surface that needs to be covered is placed against to the sheet spreading out on a flat table and a cutting line of the surface shape can be drawn on the sheet. The prop wrap is formed by trimming the sheet along the cutting line. Because the shape and size of the wrap match the surface appearance of the prop, the wrap is able to align to the surface and precisely cover the prop when it is used.

In order to quickly and precisely create wraps for a prop, the surface shape and size of the prop are pre-measured and entered into a computer. The shape of the wrap is formed on a printing template in the computer. When the wrap comprises several pieces of flexible film with different shapes, these shapes are arranged in a way that they can all be fitted into one printing template. A design of painting, coloring, or picturing is applied or pasted to these shapes on the template. After the template is printed on a continuous sheet of flexible film, the shapes are cut out from the sheet and ready to be applied to the prop. The shapes and the design on the printing template can be changed, modified, or rearranged at any time based on the type of the prop that needs to be covered and requests from performers.

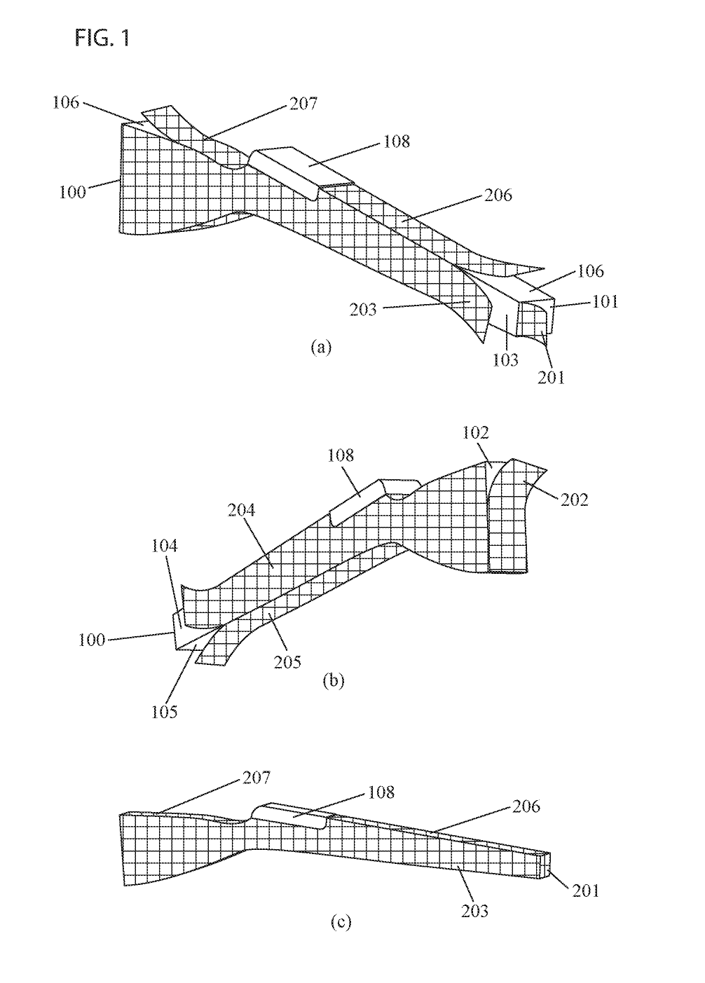

Several preferred embodiments of the current invention are described as follows. Mock rifle is a popular prop used in pageantry art shows. A typical mock rifle covered with a prop wrap is shown in FIG. 1. The mock rifle includes a shaped body 100 with a bolt 108 on its top. It has front 101, back 102, right 103, left 104, bottom 105, and upper 106 sides on its surface. Sometimes a strap (not shown in the figure) may be also installed on its bottom. Either the bolt or the strap is affixed to the body 100 by fasteners.

The prop wrap for this mock rifle includes seven pieces of flexible film, 201, 202, 203, 204, 205, 206, and 207. These pieces have different sizes and shapes that match each side of the mock rifle. When they are attached to the mock rifle, as depicted in FIG. 1(a) and (b), they are able to precisely cover all sides of the mock rifle shown in FIG. 1(c).

Depending on performers' need, the bolt 108 may need to be temporarily removed so that the upper side of the mock rifle under the bolt 108 can also be covered by the wrap. In this case, the shape and size of two pieces of flexible film, 203 and 204, need to be changed accordingly so that the area under the bolt can be covered by the wrap. After the wrap is applied, the bolt 108 is reattached on top of the wrap and affixed to the mock rife by fasteners. When the mock rifle has a strap, it needs to be removed first in order for the prop wrap to be attached to the bottom side of the mock rifle before it is reattached. In other embodiments, the prop wrap comprise less than seven pieces of flexible film when not all sides of the mock rifle need to be covered. For example, the prop wrap may have two pieces of flexible film, which covers only the left and right sides of the mock rifle. The prop wrap may also include four pieces of flexible film to cover all sides of the mock rifle except the front and the back sides. The grid pattern shown on the prop wrap in FIG. 1 can be replaced by other designs such as pictures, images, symbols, logos, letters, or color patterns. In some embodiments star or broom images are printed on the apparent side of the prop wrap. In some other embodiments the prop wrap has blue or green color patterns on its apparent side.

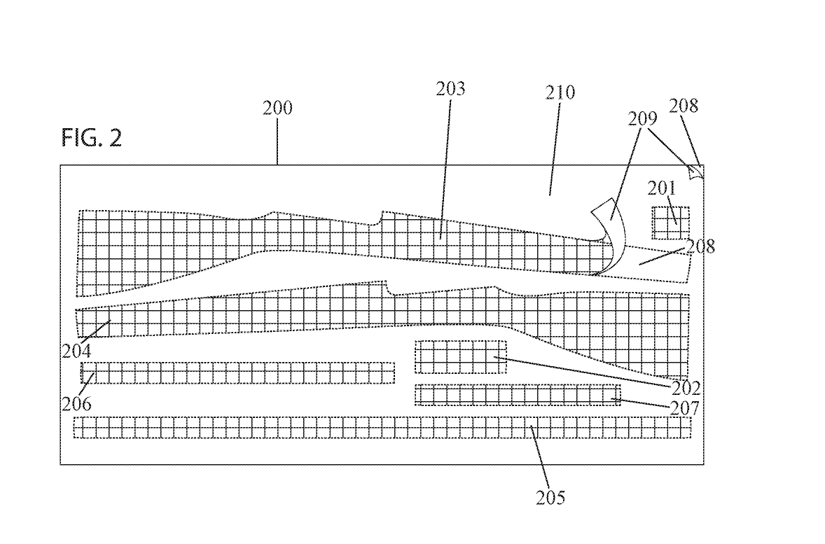

FIG. 2 shows a top view of a continuous sheet of flexible film 200, which has a unique, custom-matched cutting pattern that corresponds exactly to the surface shape and size of the mock rifle shown in FIG. 1. The cutting pattern is generated by a computerized template based on the size data of the prop wrap entered into the computer. The flexible film 200 has two sides, the apparent side 210 and the adhesive side 209. A protective film 208 is attached to the adhesive side 209 for separating it from the environment.

As shown in FIG. 2, a grid design is printed on the apparent side 210 of the flexible film. The edge (showed by the dashed line in the figure) of the design forms the cutting pattern for seven shapes on the continuous sheet 200. These shapes are cut out along the edge to become seven pieces of flexible film, 201, 202, 203, 204, 205, 206, and 207. Once the protective film 208 is removed from the adhesive side 209, as depicted by the flexible film 203 in FIG. 2, these prop wraps are ready to be affixed to the mock rifle for precisely covering its sides. The shape, size, and the location of the bolt and strap change among different brands of mock rifles. The cutting pattern also varies to match these changes and difference. As being discussed in the previous paragraph, the design on the prop wrap can also be changed in other embodiments.

Another preferred embodiment of the current invention is the prop wrap prepared for covering a shako, which is a popular prop worn by performers in marching bands. A typical shako has a top and a cylindrical sidewall. The top is in a substantially round shape and the sidewall has a substantially cylindrical shape. A prop wrap used for covering the shako comprises two pieces of flexible film. The piece with a round shape is for being attached to the top of the shako. The cylindrical sidewall is encircled by another rectangular piece of the prop wrap. In other embodiments, the prop wrap comprises only one piece of flexible film, which is used to cover the sidewall of the shako. Various patterns are applied to the apparent side of the flexible film depending on the need of shows and activities.

The prop wrap is also used to cover a shoe's upper. The shoe includes but is not limited to boots, casual footwear, and business shoes. Depending on the size and style of the shoe, the prop wrap may include more than one piece of flexible film so that the upper is completely covered. However, the prop wrap may have only one piece of flexible film if only part of the upper needs to be covered. The shape of the wrap may be irregular so long as it can cover the designated area on the upper of the shoe.

The foregoing description of preferred embodiments for the prop wrap is presented for the purposes of illustration and description. They are not intended to be exhaustive or to limit the invention to the precise form disclosed. Obvious modifications or variations are possible in light of the above teachings. Besides the typical show props such as the mock rifle, shako, and shoe described in the foregoing paragraphs, the prop wrap can also be applied to other props including but not limited to sabres, sickles, and batons. For some props, the prop wrap comprises several pieces of flexible film. These flexible films may be available in one set or provided separately to users. All such application, modifications, and variations are within the scope of the invention as determined by the appended claims when interpreted in accordance with the breadth to which they are fairly, legally, and equitably entitled.

What is claimed is:

1. A prop wrap comprising at least one piece of flexible film for precisely covering the surface of a prop; said flexible film having an adhesive side whereon the prop wrap adheres to the prop's surface and an apparent side whereon a design is applied.

2. The prop wrap of claim 1 wherein the prop is a mock rifle.

3. The prop wrap of claim 2 comprising two pieces of flexible film, wherein one flexible film is used to precisely cover the left side of the mock rifle and the other flexible film is used to precisely cover the right side of the mock rifle.

4. The prop wrap of claim 2 comprising five pieces of flexible film, wherein three pieces of said flexible film are used to precisely cover the left, right, and bottom sides of the mock rifle and two other pieces of said flexible film are used to precisely cover the upper side of the mock rifle.

5. The prop wrap of claim 2 comprising seven pieces of flexible film, wherein five pieces of said flexible film are used to precisely cover the left, right, bottom, front and back sides of the mock rifle and two other pieces of said flexible film are used to precisely cover the upper side of the mock rifle.

6. The prop wrap of claim 2, wherein said flexible film is removable after use.

7. The prop wrap of claim 2, wherein the design on said flexible film is manual drawing or printed pattern.

8. The prop wrap of claim 2, wherein the apparent side on said flexible film is printable.

9. The prop wrap of claim 1 wherein the prop is a shako.

10. The prop wrap of claim 9 comprising at least one piece of flexible film for precisely covering the shako's top, cylindrical sidewall or both of them.

11. The prop wrap of claim 1 wherein the prop is a shoe.

12. The prop wrap of claim 11 comprising at least one piece of flexible film for covering the upper of the shoe.

13. A method for preparation and application of the prop wrap of claim 1 on a prop comprising:
applying a design to the apparent side of a continuous sheet of flexible film;
measuring the size and appearance of the prop's surfaces;
cutting out the shapes that match the size and appearance of the prop's surfaces from said continuous sheet to form the prop wrap; and
using the adhesive side to affix the prop wrap to the prop and precisely cover the same.

14. The method of claim 13, wherein the prop is a mock rifle.

15. The method of claim 14, wherein the size and appearance of shapes formed on said continuous sheet are adjustable to accommodate different makes and models of the mock rifle.

16. The method of claim 13, wherein the prop is a shako or a shoe.

17. A method for preparation and application of the prop wrap of claim 1 on a prop comprising:
measuring the size and appearance of the prop's surfaces;
entering data of the size and appearance into a computerized printing template;
creating and arranging the shapes that match the size and appearance of the prop's surfaces to form a cutting pattern on the printing template;
applying a design to the shapes on the said template;
printing the said template on the apparent side of a continuous sheet of flexible film;
cutting out the shapes from said continuous sheet to form the prop wrap; and
using the adhesive side of the flexible film to affix the prop wrap to the prop and precisely cover the same.

18. The method of claim 17, wherein the prop is a mock rifle.

19. The method of claim 17, wherein the prop is a shako.

20. The method of claim 17, wherein the prop is a shoe.
